(19) United States
(12) Patent Application Publication
(10) Pub. No.: US 2004/0183934 A1
(43) Pub. Date: Sep. 23, 2004

(54) Digital camera and mobile equipment with photographing and displaying function

(75) Inventor: Hisashi Tatamiya, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/765,989

(22) Filed: Jan. 29, 2004

(30) Foreign Application Priority Data
Jan. 30, 2003 (JP) P2003 - 022066

(51) Int. Cl. H04N 5/222

(52) U.S. Cl. 348/333.02

(57) ABSTRACT

A digital camera has a display processor, a release button, and a button operation detector. The display processor displays an object image on a screen as a moving-image before photographing a still-image. The release button is operated for recording the still-image. The button operation detector, detects the contact of a finger with the release button. The display processor superimposes photograph information on the moving image when the button operation detector detects the contact.

### BACKGROUND OF THE INVENTION

1. Field of the Invention

The present invention relates to a digital camera and mobile equipment with a photographing and displaying function, especially, it relates to displaying a moving-image and photograph information before photographing a still-image.

2. Description of the Related Art

In a digital still camera, an object image, captured by a photographing optical system, can be displayed on an LCD as a “moving-image” before photographing a still-image. A user can confirm the photograph of the still-image to be recorded, and can review a composition of the still-image, without observing the object via a viewfinder.

Further, photograph information, such as an exposure correcting value, a white balance mode, and so on, can be superimposed on the moving image so that the user can confirm the photograph information associated with the still-image to be recorded before photographing. The photograph information is displayed by operating an exclusive button provided on the camera.

When the photograph information is superimposed on the moving-image, the moving-image is obstructed by the photograph information so that the visibility of the moving-image degrades and the user cannot sufficiently confirm the composition.

### SUMMARY OF THE INVENTION

Therefore, an object of the present invention is to provide a digital camera and mobile equipment with photographing and displaying functions, that are capable of superimposing photograph information such that a user can review the photograph information at any time while sufficiently confirming the composition of a still-image to be recorded.

A digital camera according to the present invention has a display processor, a release button, and a button operation detector. The display processor displays an object image on a screen as a moving-image before photographing a still-image. The release button is operated for recording the still-image. The button operation detector detects the contact of a finger with the release button. The display processor superimposes photograph information-on the moving image when the button operation detector detects the contact.

Mobile equipment with photographing and displaying functions, such as a cellular phone, according to another aspect of the present invention have a display processor, a recording button, and a button operation detector. The display processor displays an object image on a screen as a moving-image before photographing a still-image. The release button is operated for recording the still-image. The button operation detector detects the contact of a finger with the recording button. The display processor superimposes photograph information on the moving image when the button operation detector detects the touch.

### BRIEF DESCRIPTION OF THE DRAWINGS

The present invention will be better understood from the description of the preferred embodiment of the invention set fourth below together with the accompanying drawings, in which:

FIG. 1 is a perspective view of a digital still camera seen from the rear, according to the first embodiment;

FIG. 2 is a block diagram of the camera;

FIG. 3 is a view showing a display-screen in a situation where the user's finger touches the release-button;

FIG. 4 is a schematic cross section view of an upper portion of the camera;

FIGS. 5A, 5B, and 5C are schematic cross section views of the upper portion of the camera; and

FIGS. 6A, 6B, and 6C are views showing a display-screen of the LCD monitor in the photograph mode.

### DESCRIPTION OF THE PREFERRED EMBODIMENTS

Hereinafter, the preferred embodiment of the present invention is described with reference to the attached drawings.

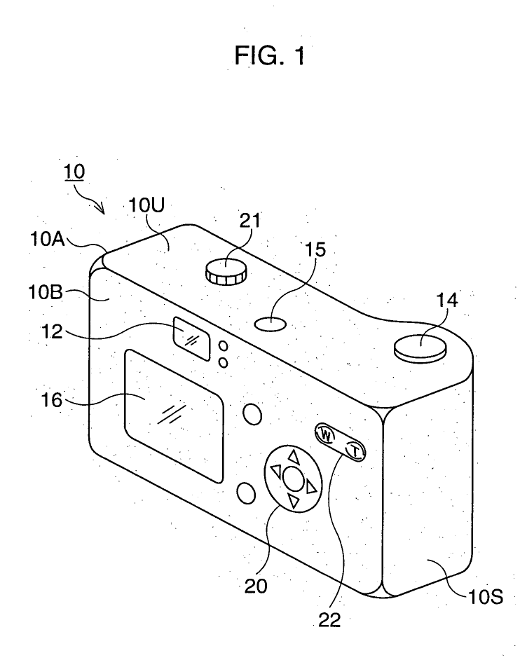

FIG. 1 is a perspective view of a digital still camera seen from the rear, according to the first embodiment. The digital still camera is a compact camera so that a user can record a still-image while holding the camera by only one hand.

On an upper surface 10U of the digital still camera 10, a release button 14, a mode dial 21, and a power switch button 15 are provided. The mode dial 21 is operated for selecting a given mode from a photograph mode, an exposure-setting mode, and a replay-mode. On the front surface of the digital still camera, a lens barrel (not shown) is mounted on the camera body 10A.

On a back surface 10B of the camera 10, an eyepiece 12, an LCD monitor 16, a cross-shaped setting button 20, and a zoom button 22 are provided. The setting button 20 is operated when the exposure-setting mode is selected by using the mode dial 21. The user sets an exposure and customizes the camera 10 by operating the setting button 20. The zoom button 22 is operated when zooming with a photographing optical system (herein not shown) provided in the lens barrel. On a side surface 10S of the camera 10, a card slot (not shown) for installing a memory card (herein not shown) is formed.

When the photograph mode is selected, a still-image is recorded by operating the release button 14. Users operate the release button 14 with the index finger of their right hand. Further, an object image, captured by the photographing optical system, is displayed on the LCD monitor 16 as a “moving-image” during the photograph-mode. When the exposure-setting mode is selected, the exposure is determined by operating the setting button 20.

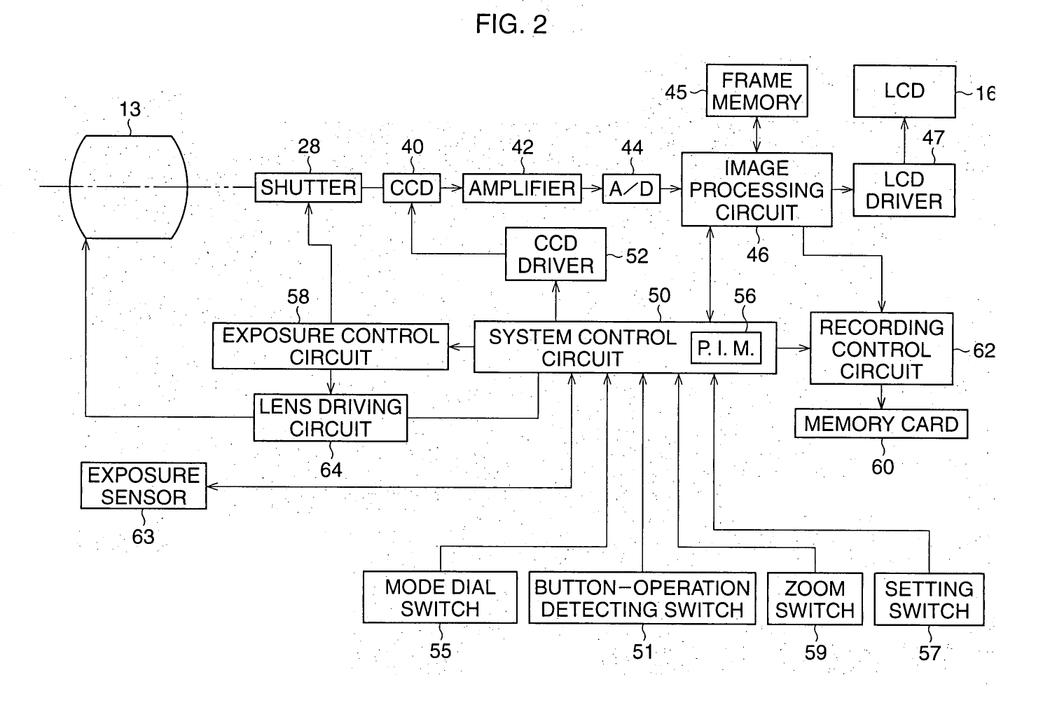

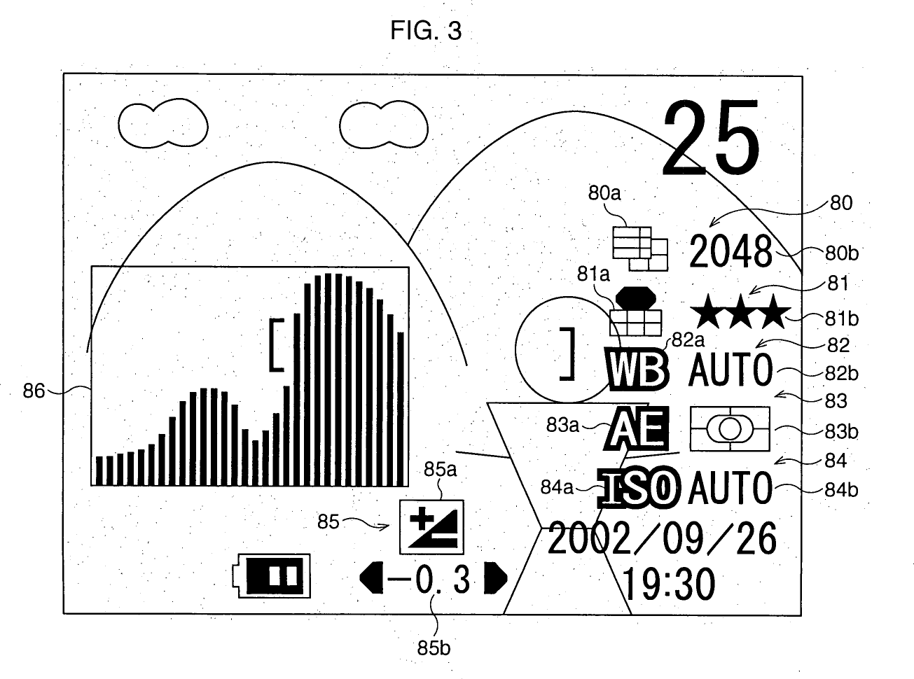

FIG. 2 is a block diagram of the camera 10. FIG. 3 is a view showing a display-screen in a situation where the user's finger touches the release button 14.

A system control circuit 50 including a CPU controls the digital still camera 10, and a button-operation detecting switch 51, a mode dial switch 55, a zoom switch 59, and a setting switch 57 are connected to the system control circuit 50. In the mode dial switch 55, a signal corresponding to the selected mode is output to the system control circuit 50. When the zoom button 22 or the setting button 20 is operated, an operation signal corresponding to the operated button is fed from the zoom switch 22 or the setting switch 20 to the system control circuit 50. In a photograph information memory 56 of the system control circuit 50, data associated with photograph information, such as an exposure correcting value, metering manner, and so on, is stored. The data is rewritten in accordance with the operation of the setting button 20.

When the photograph mode is selected by operating the mode dial 21, signal processes for displaying the moving-image are performed. Light passing through the optical photographing system 13 and a shutter 28 reaches a CCD 40, so that an object image is formed on the CCD 40 and analog image-pixel signals are generated in the CCD 40 by the photoelectric effect. The generated image-pixel signals are successively fed to an amplifier 42. A CCD driver 52 drives the CCD 40.

The image-pixel signals are amplified by the amplifier 42, and are converted to digital image signals in an A/D converter 44. The digital image signals are fed to an image processing circuit 46, wherein various processes, such as a white balance process, gamma correcting process, and so on, are performed. The processed digital image signals are temporarily stored in a frame memory 45 and fed to a LCD driver 47. The LCD driver 47 drives the LCD monitor 16 on the basis of the fed image signals so that the object image is displayed on the LCD monitor 16 as a moving-image.

When users touch their finger (index finger) on the release button 14 during the photograph mode, the button-operation detecting switch 51 detects the touch by their finger. Then, a control signal is fed from the system control circuit 50 to the image processing circuit 46 to display the photograph information on the LCD monitor 16. Thus, the photograph information is superimposed on the moving-image in the LCD monitor 16 (See FIG. 3).

Herein, a recording size 80 defining image-resolution, a recording image-quality 81 defining a compression rate of a recorded image, a white balance mode 82, a metering manner 83, an ISO sensitivity 84, an exposure correcting value 85, and a histogram 86 indicating a brightness distribution are superimposed on the moving-image. Each item of the photograph information is associated with the photograph operation, and determines the image-quality of a recorded still-image. The 6 setting items, the recording size 80, the recording image-quality 81, the white balance mode 82, the metering manner 83, the ISO sensitivity 84, and the exposure correcting value 85, are associated,with the photograph condition or photograph quality. The user can change manner or value of any or all of the 6 items. On the other hand, the histogram 86 is information, which represents a situation of an object to be photographed.

Each of the 6 items, the recording size 80, the recording image-quality 81, the white balance mode 82, the metering manner 83, the ISO sensitivity 84, and the exposure correcting value 85, is represented by a symbol mark, which indicates the item, and a setting condition, which represents a setting condition information, such as an exposure-value, a photograph manner, and so on. In the case of the recording size 80, a symbol mark 80a representing image-resolution and literal information 80b representing a number of pixels “2048”, are displayed on the monitor 16. In the case of the recording image-quality 81, a symbol mark 81a representing image-quality and character information 81b represented by an arrangement of star-marks, wherein the number of star-marks indicates the compression rate. Similarly, the white balance mode 82 is represented by the symbol mark 82a and the literal information 82b, which represents one of an automatic mode, a daylight mode, and fluorescent-light mode (herein, the automatic mode). The metering manner 83 is represented by the symbol mark 83a and character information 83b, which represents one of a division metering, a spot metering, and a center weighted metering. The ISO sensitivity 84 is represented by the symbol mark 84a and the literal information 84b, which represents an automatic setting or a value of the ISO sensitivity. The exposure correcting value 85 is represented by the symbol mark 85a and the literal information 85b indicating a value of the exposure correcting value.

When the release button 14 is halfway depressed, the button-operation detecting switch 51 detects the half-depression. Then, the brightness of the object and the distance between the object and the camera 10 are measured by an exposure sensor 63, which is provided on the front surface of the camera 10. The measured exposure values are superimposed on the moving-image (herein not shown) Further, when the release button 14 is fully depressed, the button-operation detecting switch 51 detects the full-depression, and the photographing action is performed. Namely, a lens driving circuit 64 drives a focus lens in the photographing optical system 13 to adjust the focal point. Then, the shutter 28 opens by a predetermined amount in accordance with a control signal fed from an exposure control circuit 58. The lens driving circuit 64 and the shutter 28 are controlled by the exposure control circuit 58, which outputs driving signals in accordance with control signals fed from the system control circuit 50. When light passing through the photographing optical system 13 reaches the CCD 40 and the object image is formed on the CCD 40, one frame worth of the image-pixel signals is generated in the CCD 40. The image-pixel signals are fed to the amplifier 42, the A/D converter 44, and the image-processing circuit 46. The processed digital signals in the image processing circuit 46 are temporarily stored in the frame memory 45, and are fed to a recording control circuit 62 via the system control circuit 50. The digital image signals are subjected to a compression process in the recording control circuit 62, and the compressed image signals are recorded in the memory card 60 as image-data.

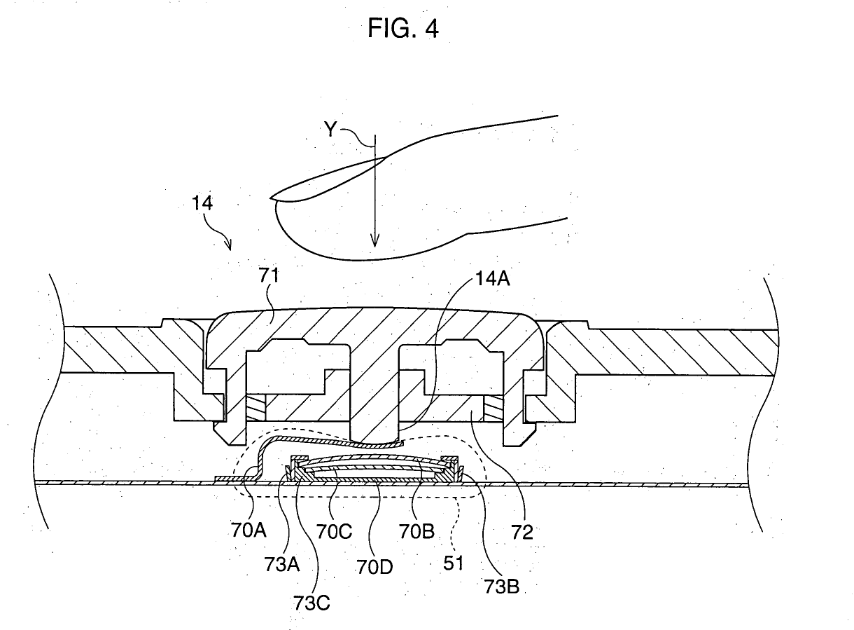

FIG. 4 is a schematic cross section view of an upper portion of the camera 10.

The release button 14 is composed of an upper portion 71 and an under portion 72, the upper portion 71 being movable along a depression-direction (shown by an arrow “Y”) relative to the under portion 72. The button-operation detecting switch 51 is provided under the release button 14, and has a first conductive and elastic contact plate 70A, a second conductive and elastic contact plate 70B, a third conductive and elastic contact plate 70C, and an electric contact 70D. The first contact plate 70A usually touches an extending portion 14A of the upper portion 71. The second and third contact plates 70B and 70C are supported by a pair of supporting end members 73A and 73B, and a base supporting member 73C, whereas the electric contact 70D is located in the center portion of the base supporting member 73C.

The first, second, and third contact plates 70A, 70B, 70C, and the contact 70D are separately stratified so as to maintain a given interval from each other, and are respectively connected to corresponding wires (not shown). When the release button 14 is operated, the first contact-plate 70A is urged toward the second, and third contact plate 70B, 70C, and the contact 70D. Note that, no spring is provided between upper portion 71 and the under-portion 72.

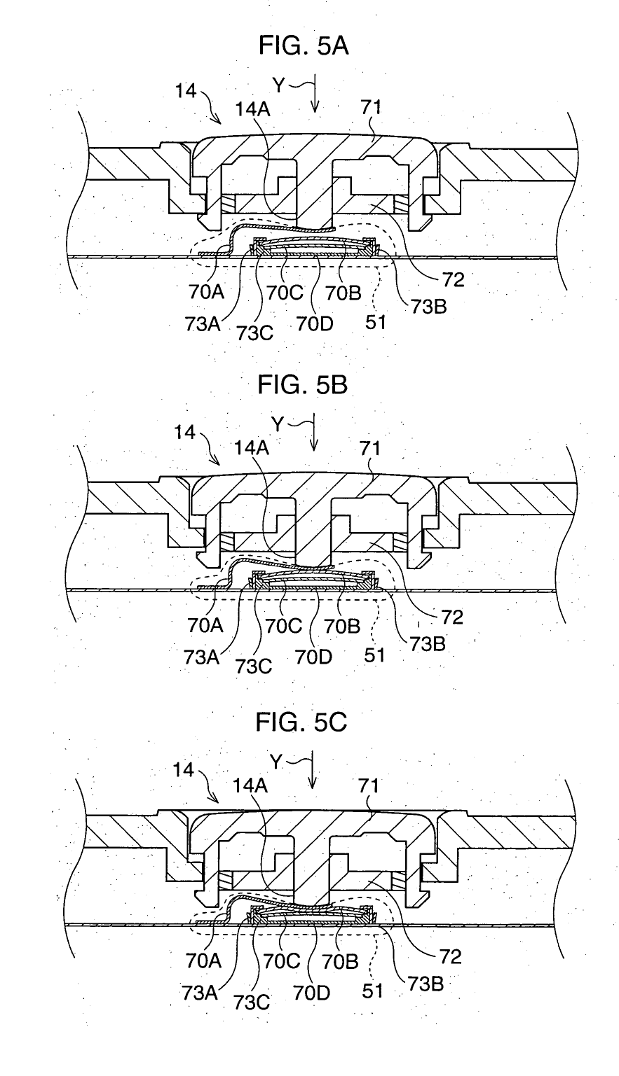

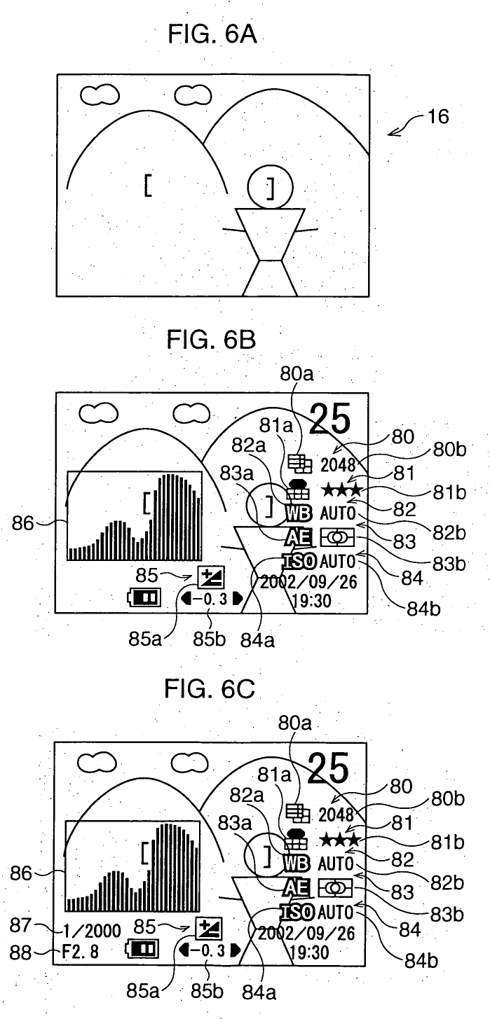

FIGS. 5A, 5B, and 5C are schematic cross section views of the upper portion of the camera 10. FIGS. 6A, 6B, and 6C are views showing a display-screen of the LCD monitor 16 in the photograph mode. With reference to FIGS. 5A and 5B, and FIGS. 6A, 6B, and 6C, the display-action, which varies with the operation to the release button 14, is explained.

When the user's index finger does not touch the release button 14 (hereinafter, called an “initial state”), the first contact member 70A does not touch the second contact plate 70B (See FIG. 5A). Therefore, a detecting signal is not output, from the button-operation detecting switch 51 so that a moving-image is displayed, in other words, the photograph information is not displayed (See FIG. 6A).

When the user's index finger touches the release button 14 (hereinafter, called a “contact-state”), the first contact plate 70 is deformed and touches the second contact plate 70B (See FIG. 5B). Consequently, a detecting signal corresponding to the touch is output from the button-operation detecting switch 51 and the photograph information is superimposed on the moving-image (See FIG. 6B). Note that, in the “contact-state”, the pressing power that is necessary to achieve “half-depression”, is not transferred from the finger to the release button 14 by the user. The finger is only put on the release button 14. When the finger is released from the release button 14, the first contact plate 70A returns to its original position so that the photograph information is erased from the LCD monitor 16.

When the setting button 20 is operated by the user's thumb in the “contact-state”, an operation signal corresponding to the setting is fed to the photograph information memory 56. In the photograph information memory 56, data associated with the photograph information changed by the user is rewritten so that changed photograph information is displayed on the LCD monitor 16.

When the release button 14 is halfway depressed, the third contact plates 70C touches the second contact plate 70B while the first and second contact plates 70A and 70B contact each other (See FIG. 5C). Consequently, a detecting signal corresponding to the half-depression is fed to the system control circuit 50. Thus, other photograph information, namely, a shutter speed 87 and a diaphragm value 88 are further superimposed on the moving-image (See FIG. 6C). Further, when the release button 14 is fully depressed, the third contact plate 70C touches the electric contact 70D in a situation where the first contact plate 70A touches the second contact plate 70B and the second contact plate 70B touches the third contact plate 70C (not shown). Thus, a still-image is recorded in the memory card 60.

In this way, in this embodiment, the button-operation detecting switch 51, which is composed of the first, second, and third contact plates 70A, 70B, and 70C, and the electric contact 70D, is provided under the release button 14. Then, the button-operation detecting switch 51 detects the “contact-state”, the “half-depression”, and the “full-depression”. When the user's finger touches the release button 14, the first contact plate 70A touches the second contact plate 70B so that the photograph information is superimposed on the moving-image displayed on the LCD monitor 16. Further, when the release button 14 is halfway depressed, the exposure values 87 and 88, which indicate the proper photograph conditions for a photographed object, are superimposed.

According to this embodiment, photograph information 80 to 86, which occupies the majority of the monitor 16, is not displayed until the user's finger touches the release button 14. Namely, the composition or framing is given priority. Accordingly, the user can easily review the composition without seeing the superimposed photograph information. Then, after deciding the framing, all of the photograph information is displayed at the same time. Thus, the user can easily confirm all of the photograph conditions soon after the framing is decided.

The user can review whether the photograph information such as the metering manner and the white balance mode is proper for the object, before halfway depressing the release button 14. Accordingly, when the user judges that the composition is not proper, the user can change the photograph information before deciding the exposure values (shutter speed and diaphragm value). Further, since the photograph information is erased from the LCD monitor 16 by releasing the finger from the release button 14, the user can review the object and the composition again while easily maintaining the visibility via the LCD monitor 16.

Since the digital camera 10 is a compact type camera, the user can touch-the release button 14 with the finger of the right/left hand while holding the camera in only the right/left hand. Therefore, the changing of the display/erasure of the photograph information, can be performed by only one hand.

Note that, another type of camera such as a single lens-reflex type camera may be used in place of the compact digital still camera 10. A digital movie-camera capable of photographing a still-image may be used in place of the digital still camera 10. Further, mobile equipment with a photographing and displaying function, such as a cellular phone, may be used in place of the digital camera.

Finally, it will be understood by those skilled in the art that the foregoing description is of preferred embodiments of the device, and that various changes and modifications may be made to the present invention without departing from the spirit and scope thereof.

The present disclosure relates to subject matters contained in Japanese Patent Application No.2003-022066 (filed on Jan. 30, 2003), which is expressly incorporated herein, by reference, in its entirety.

1. A digital camera comprising:
a display processor that displays an object image on a screen as a moving-image before photographing a still-image;
a release button that is operated for recording the still-image;
a button operation detector that detects a contact of a finger with said release button;
wherein said display processor superimposes photograph information on the moving image when said button operation detector detects the contact.

2. The digital camera of claim 1, wherein the photograph information represents at least one of a photograph condition and a situation of an object before recording, said photograph condition being changed by a user.

3. The digital camera of claim 1, wherein the photograph information comprises a plurality of setting items associated with a photograph condition, each item being constructed of an indicator indicating the item and setting condition information changed by a user, all said plurality of setting items being superimposed on the moving-image at the same time.

4. The digital camera of claim 2, wherein the photograph information comprises at least one of an exposure correcting value, a white balance mode, a compression rate, a recording size, an ISO sensitivity, a metering manner, and a histogram.

5. The digital camera of claim 1, wherein said button operation detector further detects a half-depression and a full-depression of said release button.

6. The digital camera of claim 5, wherein said button operation detector comprises a first, second, and third conductive and elastic contact members and an electric contact, said first contact member touching said release button, said electric contact, said third contact member, said second contact member, and said first contact member being stratified toward the release button in this order while maintaining a given interval along a depression-direction,
wherein said button operation detector detects the contact of the finger when said first and second contact members touch each other due to the finger contact, detects the half-depression when said third contact-member touches said second contact member in a situation where said first and second contact members touch each other due to the half-depression, and detects the full-depression when said electric contact touches said third contact members in a situation where said first and second contact members touch each other and said third contact member touches said second contact member due to the full-depression.

7. The digital camera of claim 5, wherein said display processor superimposes an exposure value on the moving-image when said button operation detector detects the half-depression.

8. The digital camera of claim 1 wherein said digital camera is a compact type camera wherein a user can hold said digital camera in only one hand and can operate said release button using only one finger.

9. Mobile equipment with photographing and displaying functions comprising:
a display processor that displays an object image on a screen as a moving-image before photographing a still-image;
a recording button that is operated for recording the still-image;
a button operation detector that detects a contact of a finger with said recording button;
wherein said display processor superimposes photograph information on the moving image when said button operation detector detects the contact.
